(19) United States
(12) Patent Application Publication
(10) Pub. No.: US 2021/0344813 A1
(43) Pub. Date: Nov. 4, 2021

(54) MAPPING COLOR GAMUTS

(71) Applicant: HEWLETT-PACKARD DEVELOPMENT COMPANY, L.P., Spring, TX (US)

(72) Inventors: Juan Miguel Huertas Delgado, Sant Cugat del Valles (ES); Jordi Vilar, Sant Cugat del Valles (ES); Jordi Arnabat Benedicto, Sant Cugat del Valles (ES); Jan Morovic, London (GB)

(73) Assignee: HEWLETT-PACKARD DEVELOPMENT COMPANY, L.P., Spring, TX (US)

(21) Appl. No.: 17/282,026

(22) PCT Filed: Oct. 3, 2018
(86) PCT No.: PCT/US2018/054229

§ 371 Date: Apr. 1, 2021

(51) Int. Cl. H04N 1/60

(52) U.S. Cl. CPC H04N 1/6058

(57) ABSTRACT

A method comprises obtaining at a processor a first color gamut and a second gamut represented in a first color space. The first and second gamuts are represented as first and second objects in a second color space, with each object comprising a plurality of nodes. For each node, an index is provided indicating a position in the first color space to which that node corresponds. A further index is provided indicating a position, in the first color space, of the node relative to at least one other node of the object to which the node belongs. Each node of the first object corresponds with a node of the second object providing a mapping between the objects, using the further index. The index of at least one of the first object nodes is adjusted based on the corresponding node of the second object producing a mapping between the gamuts.

### BACKGROUND

An imaging system may be arranged to output an image. Color data in an image may be represented using a first color gamut. In examples, an image represented using a first color gamut may be converted to being represented by a second color gamut. For example, a device may receive an image represented with a first color gamut and may be to output the image using the second color gamut. In such examples, a conversion or mapping between the first color gamut and the second color gamut may be used in order to convert color data between the color gamuts.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 shows a flow-chart representation of an example method according to the present disclosure.

FIG. 2 shows a schematic representation of an example apparatus for carrying out an example method described herein.

FIGS. 3A-3C show two-dimensional graphical representations of a first gamut and a second gamut in a first color space.

FIG. 4A shows the second gamut represented as a three-dimensional object in the first color space.

FIG. 4B shows the second gamut represented as a second object in a second color space.

FIGS. 5A and 5B show three-dimensional representations of a sub-object of the second object of FIG. 46.

FIG. 6 shows further three-dimensional representations of further sub-objects of the second object of FIG. 4B.

FIG. 7 shows first and second objects representing the gamuts in the second color space.

FIG. 8A shows a schematic representation of a weighting map for mapping between the first gamut and the second gamut.

FIG. 8B shows a schematic representation of a morphed gamut.

FIG. 9 shows a graphical representation of part of an example method.

### DETAILED DESCRIPTION

Certain examples described herein relate to color mapping for an imaging system. Color mapping is a process by which a first representation of a given color is mapped to a second representation of the same color. Although color is a concept that is understood intuitively by human beings, it can be represented in a large variety of ways.

For example, color-related representations may be categorized into four main types: spectral representations; appearance representations; colorimetric representations; and device-dependent representations. Spectral representations consider properties such as power, intensity, reflectance and transmission as a function of wavelength across the visible spectrum. This is a representation of one or more physical properties that relate to color that is independent of human vision. Appearance representations predict human color perception instead of describing physical colorimetric stimuli. Colorimetric representations express a human observer's visual response to a stimulus in terms of its color. Example colorimetric representations are CIE XYZ color space and color spaces derived from it, e.g., CIELAB etc. Certain color spaces, such as CIELAB, are designed to be perceptually uniform with respect to a human observer's visual response. That is, equal changes in position within a perceptually uniform color space result in equal differences in color perceived by a human observer.

In the context of device-dependent representations, a device color model may be used to associate device color spaces with colorimetric and/or spectral ones, by predicting the latter from the former. The association between spectral and calorimetric spaces may not be based on a color model, but rather defined using a system of colorimetry, such as those defined by the CIE, which results in XYZ and derived spaces. For each color representation, values within that representation may be visualized as expressing a position along the variable dimensions of a particular color space used by the representation.

For example, device-dependent representations represent color in a manner that is specific to a particular imaging device. For example, a device-dependent color space may be based on a color model, such as a Red, Green, and Blue (RGB) color model, wherein a given point in the device-dependent color space is specified using a value defining an amount of each of a red primary, a green primary, and a blue primary at that point. Similarly, a device-dependent color space may use a Cyan, Magenta, Yellow (CMYK) color model, wherein a given point in the device-dependent color space is specified using a value defining an amount of each of a cyan primary, a magenta primary, a yellow primary. In another example, a device-dependent color space may use a Cyan, Magenta, Yellow, Key/Black (CMYK) color model, wherein in addition to CMY primaries, an amount of black is specified for the given point. However, such a specification of a given point within a device-dependent color space does not define a colorimetric value for the color represented by the given point: the given point attains colorimetry based on the properties of the specific imaging device. For example, returning to the device-dependent color space based on an RGB color model, the given point, having given values of R, G and B, attains a calorimetric value by the colorimetric values of the red, green and blue primaries used by the specific imaging device.

When working with color, the term gamut may refer to a multi-dimensional volume in a color space that represents color values that may be represented by an imaging system. Certain calorimetric color spaces, such as CIELAB, are three-dimensional to correspond with human perception of color. Device-dependent color spaces have a number of dimensions that are based on the nature of the imaging device as described above; this number may be three, or may be greater or lesser than three. A gamut may take the form of an arbitrary volume in a calorimetric color space wherein color values within the volume are available to the imaging system but where color values falling outside the volume are not available. The terms color mapping, color model, color space and color gamut, as explained above, will be used in the following description.

Imaging devices described in examples herein, such as printers or display devices, or a computing device in communication with such an imaging device, may implement a color transformation that converts an image received as an input and represented with a first gamut, to output the pixels using a second gamut. For example, an output device may receive an image represented with a first, reference or source, gamut, and may output the image using second, destination or device, gamut. However, the reference gamut and the device-dependent gamut may define a different volume in a colorimetric color space, such as CIELAB.

In an example, a display device may receive images represented with an sRGB reference gamut and use a device-dependent RGB gamut to output the image. As such, in this example, both the reference gamut and the device gamut are based on an RGB color model. The device-dependent RGB gamut may comprise a color gamut which is different to the reference sRGB color gamut, for example because the colorimetric values of the RGB primaries used by the device and the calorimetric values of the RGB primaries used by the reference gamut are not the same. Therefore, when viewed in the CIELAB colorimetric color space, the device-dependent RGB gamut may define a smaller volume than the sRGB gamut, or may define a subset of the sRGB gamut. In other examples, the device-dependent RGB gamut may be larger than the sRGB color gamut, or the device-dependent color gamut and sRGB gamut may have the same size but occupy different volumes in the CIELAB color space.

In another example, an imaging device may comprise a device-dependent gamut comprising a set of colors represented using a CMY, or CMYK model. For example, the imaging device may be a printer using cyan, magenta, yellow and black ink to print images. Images received for printing by the printer may be received in a reference gamut, such as sRGB, as described above for an RGB output device. In a similar manner to as described above for a device-dependent RGB gamut, the CMY/K device-dependent gamut of a printer may occupy a different volume, for example a different sized volume in the colorimetric color space. Examples described herein provide a method of converting between two different gamuts, such as the example reference color gamut and device-dependent color gamuts described above. Examples described herein provide a morphed color gamut formed by morphing a first gamut to a second gamut.

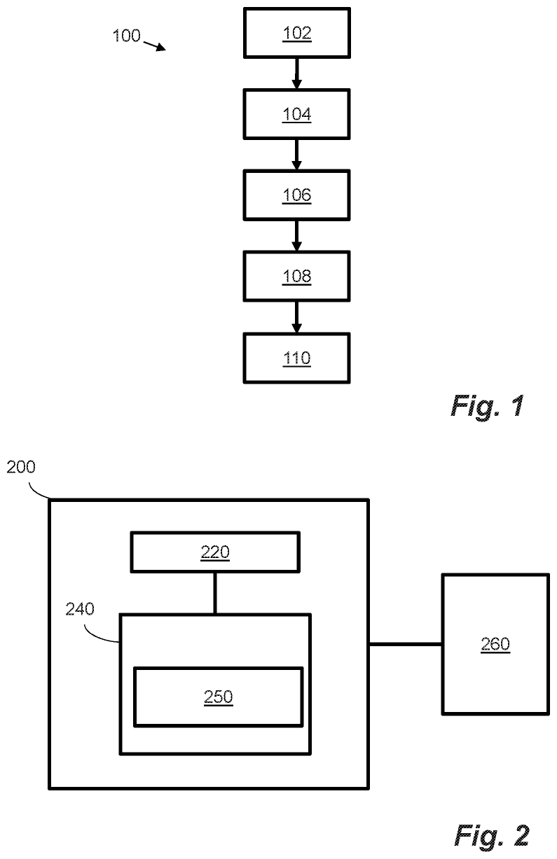

FIG. 1 shows a flow-chart representation of an example method 100 according to the present disclosure. At block 102, the method comprises obtaining, at a processor, a first color gamut represented in a first color space. At block 104, the method comprises obtaining, at the processor, a second color gamut represented in the first color space. At block 106, the method comprises representing the first color gamut as a first object in a second color space, and representing the second color gamut as a second object in the second color space, wherein the first object in the second color space comprises a first plurality of nodes and the second object in the second color space comprises a second plurality of nodes. For each node of the first plurality of nodes and each node of the second plurality of nodes there is provided an index indicating a position in the first color space to which that node corresponds. For each node of the first plurality of nodes and each node of the second plurality of nodes there is provided a further index. For a node of the first plurality of nodes, the further index is indicative of a position, in the first color space, of the node relative to at least one other node of the first plurality of nodes. For a node of the second plurality of nodes, the further index is indicative of a position, in the first color space, of the node relative to at least one other node of the second plurality of nodes. At block 108, the method comprises providing a mapping between the first object and the second object by corresponding each node of the first plurality of nodes with a node of the second plurality of nodes and each node of the second plurality of nodes with a node of the first plurality of nodes by using the further index. At block 110 the method comprises adjusting the index of at least one of the first plurality of nodes based on the index of the node of the second plurality of nodes to which the node of the first plurality of nodes corresponds. Further examples of methods according to FIG. 1 will be described below with reference to the remainder of the figures.

FIG. 2 shows example apparatus 200 for implementing example methods according to the present disclosure. The example apparatus 200 is a device comprising a machine-readable storage medium 240 coupled to a processor 220. The machine-readable storage medium 240 comprises a set of instructions 250 which when executed by the processor 220 cause the apparatus 200 to implement a method according examples described herein. In examples, the processor 220 receives a first gamut and a second gamut represented in a first color space. Upon executing the machine-readable instructions 250 the processor 220 produces a morphed version of the first color gamut. The apparatus 200 may subsequently use the morphed gamut, produced by executing the machine readable instructions 250, to convert images between being represented by the first gamut to being represented by the second gamut.

In the example of FIG. 2, the apparatus 200 is in communication with an imaging device 260. For example, the apparatus 200 may be a computing device which is in communication with an imaging device 260. The imaging device 260 may, for example, be a printer or a display device. In one example, a method described herein takes place during the design and computation of color resources for the imaging device 260, such as the initialization, quality checking, or setup process for a printer. For example, the set of instructions 250, may be executed by the processor 220 to morph a first, reference, gamut, to the device gamut of the imaging device 260. In some examples, the morphed gamut produced by the method may be encoded in a profile characterizing the imaging device 260 and allowing conversion between the reference gamut and the device gamut. The profile may, in some examples, be stored on storage medium 240 of the apparatus 200 which is communication with the imaging device 260. In other examples, a morphed gamut may be produced by morphing the second, device, gamut to the first, reference, gamut.

The morphed reference gamut produced by the execution of the instructions 250 by the processor 200 may be used to map images from the reference gamut to the device gamut, for output by the imaging device 260. While in one example, as described above, the method of producing the mapping may be part of the setup of the imaging device, in another example, the mapping process may be carried out in relation to an in-service imaging device, such as an in-service printer. For example, the mapping process may be executed to respond to a printer's given state. That is, the device gamut of the imaging device 260 may, in some examples, be dependent on the configuration of the output device 260. For example, the device gamut of a printer may depend on the combination of the printer and the print medium, e.g. paper, on which the printer is to print. The device gamut may also depend on printing parameters, such as print mode, quality, speed, number of passes, resolution, halftoning setting, etc. and on the properties of the set of inks used, e.g. whether photoblack or matteblack is used. As such, a new device gamut may be created depending on the configuration of the output device 260. When a new device gamut is created the method described herein may be executed to produce a new morphed gamut, this time wherein the reference gamut is morphed to the new device gamut. As such, methods described herein may be performed after initialization of the example output device 260, in order to take account of changes in the configuration of the output device 260 and resulting changes in the device gamut.

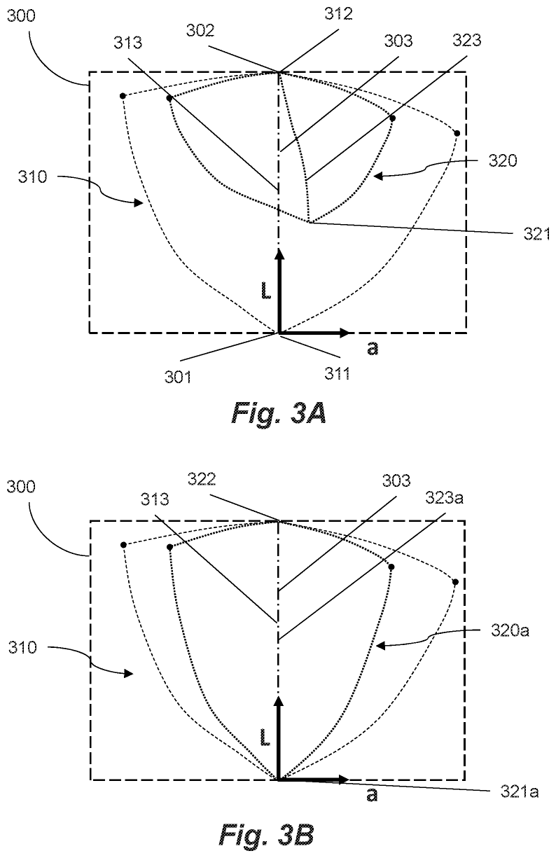

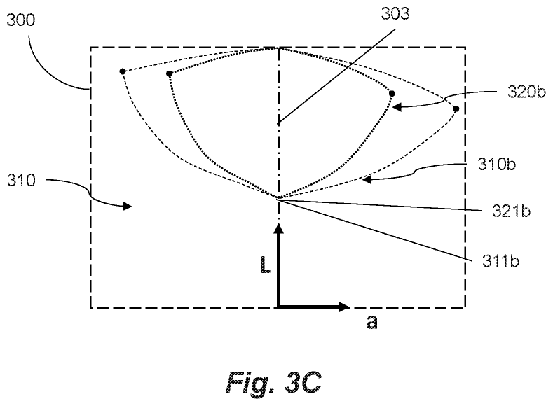

FIGS. 3A to 3C show examples relating to the obtaining, by the processor 220, of a first gamut 310 and a second gamut 320 represented in a first color space 300, as mentioned above at block 102 and block 104.

FIG. 3A shows the first color space 300. The first color space 300 in this example is the CIELAB color space, i.e. a device-independent, colorimetric color space. CIELAB is used as the first color space 300 in the example method described herein because, as described above, it is a color space which is designed to be perceptually uniform to the human observer. In the representation of FIGS. 3A and 3B, two-dimensions of the first color space 300 are shown: lightness, L, is represented along the vertical axis, while the horizontal axis represents a hue value, in this example the value a of the L*a*b representation. In the example shown in FIGS. 3A and 3B, the intersection of the axes represents a black point 301 of the first color space 300, having L=0 and hue=0 (i.e. a=0 and b=0). The first color space 300 also comprises a white point 302 having L=100, i.e. a maximum value of L, and hue=0.

In this example, the first color space 300 may be considered to be an intermediate color space which is used for defining a relationship between the first color gamut 310 and the second color gamut 320. In examples, the first color space 300 may be a Profile connection space, PCS, used under techniques proposed by the International Color Consortium, ICC. In such a technique, the first gamut 310 is represented in the PCS, as is the second gamut 320. The first gamut 310 and second gamut 320 then may be related or compared to each other via the calorimetric values they comprise in the PCS. The colorimetric values referred to here are, in the example of FIGS. 3A to 3C, the set of L*a*b coordinates which he respectively within each of the first gamut 310 and the second gamut 320. As such, representing the first gamut 310 and second gamut 320 in the first color space 300, or PCS, in this example involves providing a set of L*a*b values falling within each of the first gamut 310 and the second gamut 320. This can provide for an unambiguous connection between the first gamut 310 and the second gamut 320, which may not be possible when either or both of the first gamut 310 and the second gamut 320 are represented with their respective color models.

In this example, the first gamut 310 is an sRGB gamut. As such, the first color gamut 310 is a reference color gamut produced with an additive color model. The first gamut 310 comprises a black point 311 which, in this example, is coincident with the black point 301 of the color space 300. The black point 311 of the first gamut 310 is coincident with the black point 301 of the first color space 300 since the black point 311 represents a point represented in the RGB model having (R, G, B) =(0, 0, 0). In this example, the first color gamut 310 is shown to have a white point 312 which is coincident with the white point 302 of the color space 300, although in other examples, this may not be the case. In this example, when represented in the RGB color model of sRGB, the white point 312 has maximal values for each of R, G and B, e.g. (255, 255, 255) for 16-bit RGB values.

In this example, the second gamut 320 is a device-dependent gamut. In one example, the second gamut 320 is the device-dependent gamut of the imaging device 260 which is produced with a subtractive color CMY color model. As shown in FIG. 3A, the second gamut 320 comprises a black point 321 which is not coincident with the black point 301 of the first color space 300. The black point 321 of the second gamut 320, in this example, is the point produced by a color output by the imaging device 260 having the maximal value for each of C, M and Y. The white point 322 of the second gamut 320 in this example is shown to be coincident with the white point 302 of the color space 300. The white point 322 of the second gamut 320 corresponds to the L*a*b value, of an output having (C, M, Y)=(0, 0, 0), e.g. the L*a*b of the print medium being printed on by imaging device 260. In another example, the second gamut 320 is produced with an additive, RGB color model, as described above for the first gamut 310. In examples described herein throughout, the second gamut 320 will be described assuming that it is produced by the imaging device 260 using an RGB color model.

In some examples, methods described herein may be applied to provide a mapping between two color gamuts each having a black point which may or may not be coincident with the black point 301 of the first color space 300 and a white point which may or may not be coincident with the white point 302 of the first color space 300.

The first color space 300 comprises a set of L*a*b values lying between the black point 301 and white point 302 along the lightness axis, i.e. having hue=0 (a=0, b=0). This set of values is referred to as the gray axis 303 of the first color space 300. The first gamut 310 and the second gamut 320 can also each be considered to have a gray axis, which, for a particular gamut, is the set of points lying between the black point of the gamut and the white point of that gamut. That is, the gray axis of each gamut is the set of colors produced by adding equal amounts of each primary color used in the color model of that gamut. The gray axis of a gamut may not be a straight line when represented in the first color space 300. For example, in an RGB device-dependent gamut, wherein colors in the gamut are defined by (R, G, BY) coordinates, each having minimum value 0 and maximum value 255, the gray axis is the line comprising the colors (0, 0, 0) and (255, 255, 255) and all other colors with equal values of R, G and B. When represented in the first color space 300, these values may not all have hue =0. That is, the colors on the gray axis of a particular gamut may not be gray as measured in the first color space 300.

In this example, the first gamut 310 has a gray axis 313 comprising the set of points in the first color space 300 lying between the black point 311 of the first gamut 310 and the white point 312 of the first gamut 310. In this example, the gray axis 313 of the first gamut 310 in the first color space 300 is coincident with the gray axis 303 of the first color space 300.

In this example, the second gamut 320 has a gray axis 323 comprising the set of points lying between the black point 321 and white point 322 of the second gamut 320. As can be seen in FIG. 3A, the gray axis 323 of the second gamut 320 is not a straight line in the first color space 300 since the gray axis 323 is a function of the primaries used by the imaging device 260 to which the second gamut 320 belongs, as described above.

Example methods according to the present disclosure comprise aligning the first gamut 310 and the second gamut 320 with respect to the gray axis 303 of the first color space 300. In the example shown in FIGS. 3A to 3C, the first gamut 310 is already aligned with the gray axis 303 and so no alignment operation for the first color gamut 310 is done.

In the example of FIG. 3B, the alignment operation is performed by shifting the second gamut 320 to be aligned with the gray axis 303 of the first color space 300. The result of this alignment of the second gamut 320 is to produce an aligned second gamut 320a, seen in FIG. 3B. In performing the alignment operation, the black point 321 of the second gamut 320 is shifted to produce an aligned black point 321a, coincident with the black point 301 of the first color space 300. Points of the second gamut 320 which lie along the gray axis 323 of the second gamut 320 are also shifted to produce an aligned gray axis 323a of the second gamut 320 which is coincident with the gray axis 303 of the first color space 300.

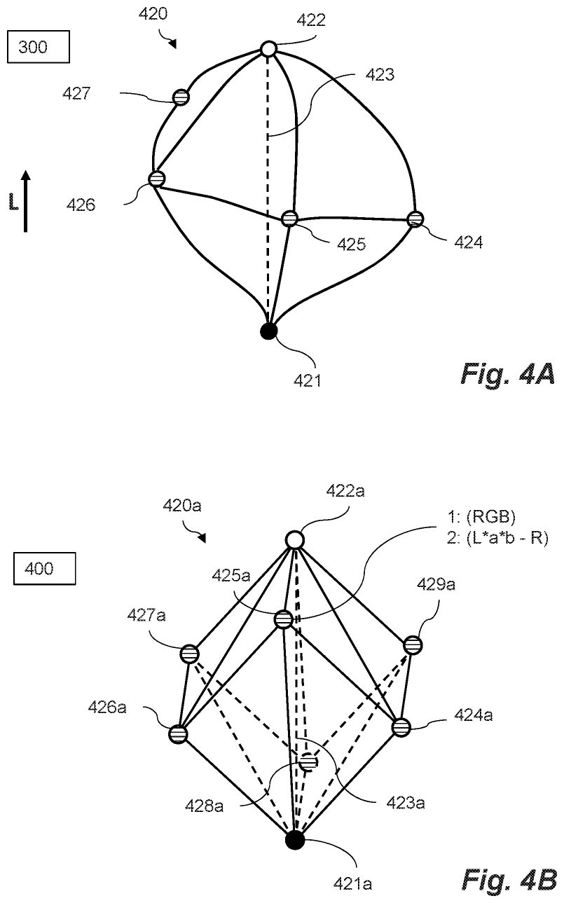

During the alignment which produces the aligned second gamut 320a of FIG. 4B, in addition to shifting the black point 321 and the gray axis 323 of the second gamut 320, points in the remainder of second gamut 320 are shifted with respect to their position relative to the gray axis 323 of the second gamut 320. That is, points in the second gamut 320 which are to the left of the gray axis 323 of the second gamut 320 are positioned to the left of the gray axis 303 of the first color space 300, and points to the right of the gray axis 323 of the second gamut 320 are positioned to the right of the gray axis 303 of the first color space 300. In examples, the alignment of the second gamut 320 may be done such that the resulting aligned second gamut 320a is substantially perceptually uniform. That is, equal distances in the aligned second gamut 320a, for instance along the L axis, as shown in the first color space 300 are representative of equal changes in colorimetry. It should be noted that the aligned second gamut 320a, since it is modified representation of the second gamut 320 in the first color space 300, comprises colorimetric, L*a*b, color values which are not within the second gamut 320, i.e. the aligned second gamut 320a comprises a different set of colors to the actual range of colors which is reproducible by the imaging device 260. The alignment can therefore be considered to be a mathematical operation which allows calibration between the first gamut 310 and the second gamut 320 in the first color space 300.

As described above, in the example of FIG. 3B, the second gamut 320 is shifted to the first gamut 310. FIG. 3C shows another example, in which the alignment between the first gamut 310 and second gamut 320 is performed such that the, after alignment, the resulting black point for each aligned gamut has a lightness value which is equal to that of the black point 321 of the second gamut 320. That is, FIG. 3C shows the second gamut 320 having been shifted to produce an aligned second gamut 320b, centered about the gray axis 303. This aligned second gamut 320b may, in one example, be produced by altering hue values of points within the second gamut 320 without altering the lightness values of said points. The first gamut 310 may then be shifted to produce an aligned first gamut 310b, comprising a new black point 311b which is coincident with a new black point 321b of the aligned second gamut 320b. The example of FIG. 3C therefore may be considered to show an example of the reference gamut 310 being shifted to the device gamut 320. In other examples, one, or both of the first gamut 310 and second gamut 320 may be aligned with respect to the gray axis 303 of the first color space 300.

Through the operations described above with reference to FIG. 3A-C, an aligned representation of the first gamut 310 and the second gamut 320 in the first color space 300 is obtained. In the example described with reference to the remainder of the figures, the alignment operation is performed as shown in FIG. 3C. Referring now to FIG. 4A, a three-dimensional representation of the first color space 300 is shown, and therein is shown a three-dimensional object 420 representing the aligned second gamut 320b of FIG. 4C. The object 420 comprises a plurality of vertices 421-422 and 424-427 and a central axis 423. The black point 321b and white point 322b of the aligned second gamut 320b are represented by vertices 421 and 422 respectively of the object 420. The central axis 423 represents the gray axis 323b of the aligned second gamut 320b.

The vertices 424, 425, 426, 427 and an additional two vertices which are not visible in FIG. 4A, represent a set of primary and secondary colors of the aligned second gamut 320a. That is, the six vertices, excluding the vertex 421 representing the black point 321b and the vertex 422 representing the white point 322b, represent the six primary and secondary colors of the color model on which the second gamut 320 is based. In this example, where the second gamut 320 is based on an RGB color model, the primary colors are red R, green G and blue B while the secondary colors are cyan C, magenta M and yellow Y. Secondary colors, as referred to herein, are colors which may be produced by equal addition of two primary colors. In another example, where the second gamut 320 is based on a CMY color model, the primary colors are cyan, magenta, and yellow, while the secondary colors are red, green, and blue. In practice and at points herein, the term primary colors may refer to both the primary colors and the secondary colors. The position in the first color space 300 of the vertices 424-427 of object 420 denote the L*a*b coordinates of the primary colors and secondary colors of aligned second gamut 320b.

In FIG. 4A, each edge of the object 420, i.e. each line between two vertices, represents a ramp in color between the respective primary or secondary colors represented by the two vertices connected by that edge. Here, a ramp in color is the set of all colors produced by beginning with a value of 0 for one of the three primaries and increasing the value for that primary to its maximal value, while keeping the values of the other two primaries constant. In the example that the object 420 represents a device-dependent RGB color space, for example, the ramp from the white point 422 to the red point 425 comprises all of the colors produced by keeping values of the green and blue primaries at 0 and increasing the red primary from 0 to its maximal value. The position of points along the edge connecting the white point 422 to the red primary 425, as shown in FIG. 4A, represents the L*a*b values of the colors on the ramp between the red primary and the white point in the aligned second gamut 320b. To give another example, given that the vertex 427 represents the green primary and the vertex 426 represents the yellow primary, the edge between red vertex 425 and yellow vertex 426 is the ramp of colors produced by having red at its maximum value and green at its minimum value at the vertex 425, and increasing the value of green from 0 to its maximal value such that at vertex 426 both the red and green values are maximal, thereby producing yellow at the vertex 426.

FIG. 4B shows the aligned second gamut 320b which has been represented as an object 420a in a second color space 400. The second color space 400 in this example is a device-dependent color space. In this example, the second color space 400 is the color space of the imaging device 260 to which the second gamut 320 corresponds. As such, in this example, wherein the imaging device 260 uses an RGB color model, the object 420a is an RGB cube. The cube 420a comprises vertices 421a and 422a representing black, white, and vertices 424a-429a representing six further colors, including red, green and blue primary colors and cyan, magenta and yellow secondaries. A gray axis 423a of the second color gamut 320 is represented as a longest diagonal of the object 420a, in this example, the main diagonal of the cube 420a, connects the black point 421a with the white point 422a.

In other examples, wherein the imaging device 260 uses a CMY color model, the object 420a is a CMY cube. That is, the aligned second gamut 320b when represented in the second color space 400 comprises the entirety of the cube 420a. While in this example, the object 420a is a cube, it should be appreciated that in other examples the object 420a representing the aligned second gamut 320b in the second color space 400 may be a regular object other than a cube comprising a plurality of vertices each representing the set of primary colors represented by the vertices of object 420. In other examples, the second color space 400 may be a CMYK color space in which the aligned second gamut 320 is represented as a four-dimensional hypercube. In examples of the method described herein wherein the second gamut 320 is a gamut of a device using a CMYK color model, the cube 420a may still be represented as a CMY cube. That is, in such examples, a particular level of black may be set, i.e. a black separation level, and the cube 420a indexed as a CMY cube. The method described herein may then produce a morphed gamut which applies for the particular level of black separation. The method may be repeated for different levels of black separation to produce a separate morphed gamut specific to the particular level of black separation.

In examples, the cube 420a representing the aligned second gamut 320b in the second color space 400 is indexed with a set of indices comprising a first index and a second index. That is, for a given point in the cube 420a, the first index for that point denotes a device-dependent value defining the position of the point in the second color space 400. In this example, the first index is an RGB value denoting a position in the second color space 400, i.e. a position within the cube 420a. The second index of the set of indices denotes a point in the first color space 300 to which the point in the cube 420a corresponds. In this example, the second index is an L*a*b value of the color represented by the given point within the aligned second gamut 320b. In the example where the given point is the vertex 425a representing the red primary, the first index 1 stores the RGB value of the red primary, e.g. (255, 0, 0), while the second index 2 stores the L*a*b value of the red primary of the aligned second gamut 320b. This L*a*b value may be determined by any of a number of suitable methods, for example during the characterization of the second gamut 320 by measuring the L*a*b value of a particular RGB output, for example using a scanning device. This L*a*b value of the red primary of the second gamut 320 in this example is then shifted during the alignment operation which produces the aligned second gamut 320b. For each point in the aligned second gamut 320b, therefore, the first index and the second index defines the correspondence between the aligned second gamut 320b as represented in the first color space 300 and as represented in the second color space 400.

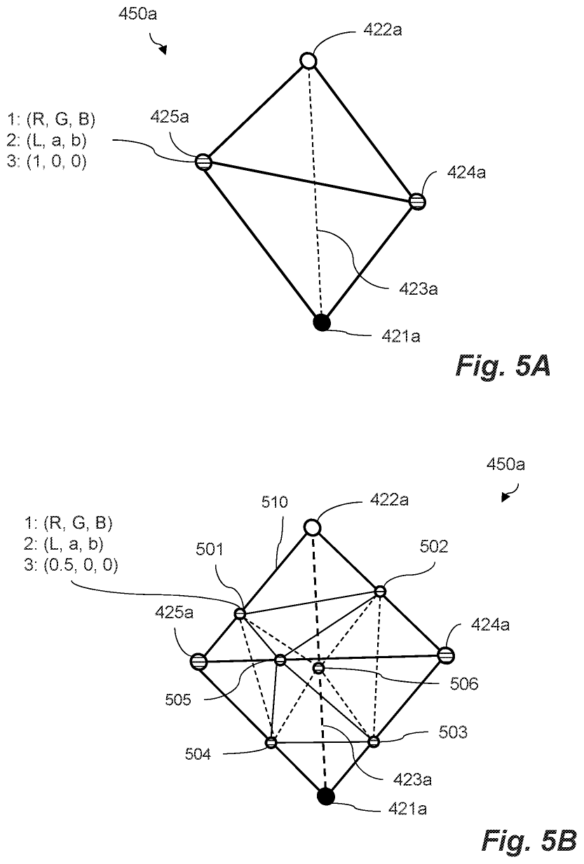

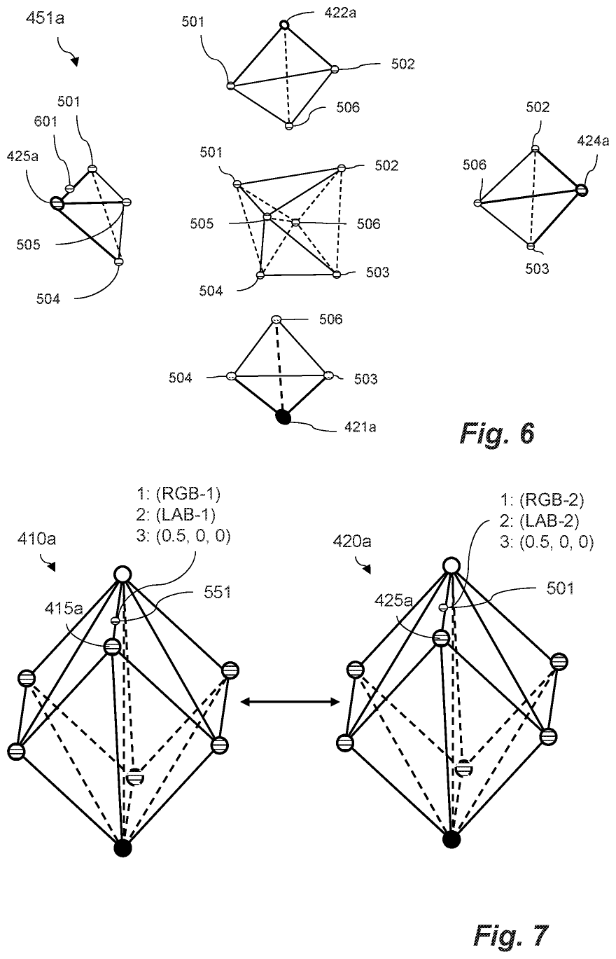

Further to the first index 1 and the second index 2, the example method described herein comprises providing a third index 3 of the set of indices for certain points within the cube 420a, The points for which a third index 3 is provided are determined as will be described below. The third index 3 is indicative of the position to which a point corresponds in the first color space 300 relative to the position in the first color space 300 to which vertices of the cube 420a correspond. The third index 3 denotes a distance of a given point, as measured in the first color space 300, from the vertices of the object 420. The points for which a third index is provided may be referred to herein as nodes. Vertices of the cube 420a may also be referred to as nodes. The determination of nodes within the object 420a and the third index for these nodes will now be described with reference to FIGS. 5A and 5B and FIG. 6.

In the example method, as described with reference to FIG. 5A, the object 420a representing the aligned second gamut 320b is divided into sub-objects. In this example, the cube 420a of FIG. 4B is divided into six tetrahedra. One tetrahedron 450a of the six tetrahedra is shown in FIG. 5A. Each tetrahedron 450a, etc., produced by this division of the cube 420a comprises four of the vertices of cube 420a and comprises the gray axis 423a of the cube 420a as one of the edges of the tetrahedron 450a. Each vertex of the tetrahedron may be provided with a value for the third index 3, The value of the third index at the vertex 425a in this example is (1, 0, 0), for reasons which will be explained with reference to FIG. 5B.

With reference to FIG. 5B, during the example method, a set of nodes is determined for providing a third index defining the cube 420a. In this example, for each edge, such as edge 510, connecting a pair of vertices of the tetrahedron 450a, a new node 501-506, which lies along this edge and which is colorimetrically equidistant from the two colors represented by the two vertices which the line connects is determined. That is, taking the edge 510 between white point 422a and red point 425a as an example, a node 501 is determined on this edge which has an L*a*b value which is equal to the point which lies on the edge between the white point 422 and the red point 425 in the first color space 300, i.e. the white to red ramp, and which is equidistant from the white point 422 and the red point 425 in the first color space 300.

In examples, determining the position of the new node 501 is done by using a recursive method to find a point in the first color space 300 which lies on the white to red ramp and which is equidistant between the white point 422 and the red point 425 in the first color space 300. In an example this involves identifying the point in the cube 420a having a value for the second index 2, i.e. an L*a*b value, for the new node 501 which is equidistant between the white point 422 and the red point 425. The first index 1 for the new node 501 is the device-dependent, e.g. RGB, value defining the position of the new node 501 in the cube 420a, Once the point 501 is identified, the third index 3 of the new node 501 is set to denote it as the mid-point between the two colors white and red in the first color space 300. The third index 3 may be similar to an RGB set of values, providing three values denoting the position of a node with respect to the RGB vertices in the first color space 300. For example, where each number of the third index ranges from 0 to 1, the new node 501 will be given a value for the third index of (0,5, 0, 0). The white point 422a then in this example has a value of (0, 0, 0) for the third index, and the red point has a value of the (1, 0, 0) for the third index, as shown in FIG. 5A.

The above-described method of determining a set of nodes and indexing each node with a third index 3 is repeated for each edge of the sub-object 450a, resulting in further new nodes 502-506 being determined and indexed. Each further new node 502-506 is given a third index 3 with a value denoting it at the mid-point of the ramp on which it is positioned.

Through this method of determining nodes which are at the mid-point of a ramp between primaries in the first color space 300, i.e. the perceptually uniform LAB color space 300, the third index 3 denotes a set of nodes which are at perceptually uniform intervals within the first color space 300 and associates these nodes with the device-dependent, e.g. RGB, values of the second color space 400.

Now referring to FIG. 6, the example method shown comprises further dividing and indexing each sub-object, e.g. tetrahedron 450a, once, or a plurality of times. With each division further sub-objects 451a, are formed. Each sub-object 451a comprises a set of vertices, e.g. 425a, 501, 505, 504 for the sub-object to the left of the figure. The vertices of each example sub-object may comprise a vertex of the cube 420a and/or nodes determined in the process described with reference to FIG. 5B, e.g, nodes 501, 504, 505,. For each sub-object e.g., sub-object 451a, of FIG. 6, the process described with reference to FIG. 5B is repeated. That is, for example for sub-object 451a, a node 601 which represents the mid-point of the nodes 425a and 501 in the first color space 300 is determined, in the same manner described with reference to FIG. 5B. In FIG. 6, one such node 601 at the mid-point of the edges of the sub-object is shown, but it should be appreciated that the example method comprises determining a node for each edge of each sub-object which connects two nodes.

The new nodes determined by the process described with reference to FIG. 6 are provided with a third index 3 which denotes these nodes as the mid-point in the first color space 300 of the ramp between the two nodes, For example, 601 is provided with a value of the third index 3 which denotes it as the mid-point in the first color space 300 of the node 501 and the node 425a. In some examples, the plurality of sub-objects 451a are further divided, once or a plurality of times and the method of determining and indexing a mid-point repeated. As such, the number of determined nodes of the cube 420a is increased and a third index 3 populated for each of these nodes.

The process described above with reference to FIGS. 4A to 6 results in the cube 420a, which represents the aligned second gamut 320b, having a plurality of nodes 501, 601, 425a, etc., each of which is indexed with a third index 3, in addition to the first index 1 and the second index 2 for that node. As described above, the third index 3 denotes the position in the first color space 300 of the colorimetric, L*a*b, value held in the second index 2 at that node. The third index 3 provided by the example method can therefore be considered to provide a quasi-perceptually uniform indexing of the cube 420a, which may be used to relate the aligned second gamut 320b, represented by the cube 420a, to the first gamut 310, as will now be described.

With reference to FIG. 7, the process described above with reference to FIGS. 4A to 6 for producing the indexed cube 420a representing the aligned second gamut 320b is repeated to produce an indexed cube 410a representing the first aligned gamut 310b of FIG. 30. A description of this process will not be repeated here. However, it should be appreciated that indexing of the cube 410a with a set of third indices 3 representing the position of each node in the first color space 300 is performed. Additionally, the cube 410a comprises a set of first indices 1 representing the RGB values in the second color space 400 of each node; and a set of second indices 2 storing the L*a*b colorimetric value represented by that node. For example, the red point 415a of the cube 410a stores: first index: (RGB) =(255, 0, 0); second index: (=L*a*b value of red primary of aligned first gamut 320b in the first color space 300); and third index: (1, 0, 0). Meanwhile, a node 551 of the cube 410a, corresponding to the node 501 of the cube 420a, has indices: first index: (RGB) =(RGB-1); second index: (LAB-1 =L*awb value of points equidistant from red primary and white primary of aligned first gamut 320b in the first color space 300); and third index: (0.5, 0, 0) denoting the point as the mid-point in the first color space 300 between the white point and the red point of the aligned first gamut 310b. The result of this process is that the cube 410a representing the aligned first gamut 310b comprises a set of first 1, second 2 and third 3 indices and the cube 420a representing the aligned second gamut 320b comprises a set of first 1, second 2, and third 3 indices.

FIG. 7 shows the cubes 410a, and 420a, representing the aligned first gamut 310 and aligned second gamut 320b respectively. Since the cubes 410a and 420a each comprise a set of indexed nodes, the cubes 410a, 420a can be related by corresponding their respective nodes, via their respective third index 3. In this example, each node 415a etc. of the cube 410a is corresponded with a node 425a etc. of the cube 425a having the same value for its third index 3. A mapping between the first gamut 310 and the second gamut 320 can therefore be produced and, for example, the first gamut 310 may be morphed to the second gamut 320.

In an example, morphing the first gamut 310 to the second gamut 320 comprises adjusting the colorimetric, i.e. L*a*b, values of points within the aligned first gamut 310b to equal the colorimetric values of the corresponding points in the aligned second gamut 320b. For example, in this example the aligned first gamut 310b is the aligned version of the sRGB gamut. The sRGB gamut has been aligned, as described with reference to FIGS. 3A-30 and represented as a cube 410a in the second color space 400. Additionally, the cube 410a representing the aligned first gamut 310b has been indexed with a set of first 1, second 2 and third 3 indices, as described above. Therefore, the example method comprises adjusting the L*a*b values of the primaries, R, G and B, of the aligned first color gamut 310b, i.e. the aligned sRGB gamut, to equal the 1.2a*I3 values held by the second indices 2 at the corresponding points in the cube 420a representing the aligned second gamut 320b. In addition to adjusting the L*a*b values of the R, G and B primaries, the method also comprises adjusting the L*a*b value held in the second index 2 of each node of the cube 410a to the L*awb value held in the second index 2 of the corresponding node of the cube 420a. For example, the L*a*b value held in the second index 2 of the node 551 of the cube 410a is adjusted to equal the L*a*b value of the node 501 of the cube 420a.

As such, in this example, the colorimetric values of the standard set of primary colors of the first gamut 310, e.g. sRGB gamut, which will be referred to here as R₁, G₁, and B₁, may be adjusted to have the same colorimetric values respectively as the primary colors of the device dependent color space 400, which will be referred to here as R₂, G₂, and B₂, Thereby producing a morphed gamut. Furthermore, in determining an L*a*b value for a point in the morphed gamut which lies between nodes, the L*a*b value for that point may be interpolated from the L*a*b values of neighboring nodes. For example, a value for the third index 3 for a given point between nodes 501 and 601 may be interpolated from the values of the third index 3 of the nodes 501 and 601. The L*a*b value to which to map the given point may then be interpolated from the L*a*b values held by the second indices 2 at each of the nodes 501 and 601. The process described thus far may be considered to be a complete morphing of the aligned first gamut 310b to the aligned second gamut 320b since all L*a*b values of the aligned first gamut 310b are adjusted to corresponding values of the aligned second gamut 32013. Following this process, in an example, actual colorimetric values present in the first gamut 310 and the second gamut 320 may be retrieved from the morphed gamut values by undoing the alignment process, e.g. performing the reverse operation of the shifting operation which was performed on each point in the gamuts in the alignment process described in FIGS. 3A-3C.

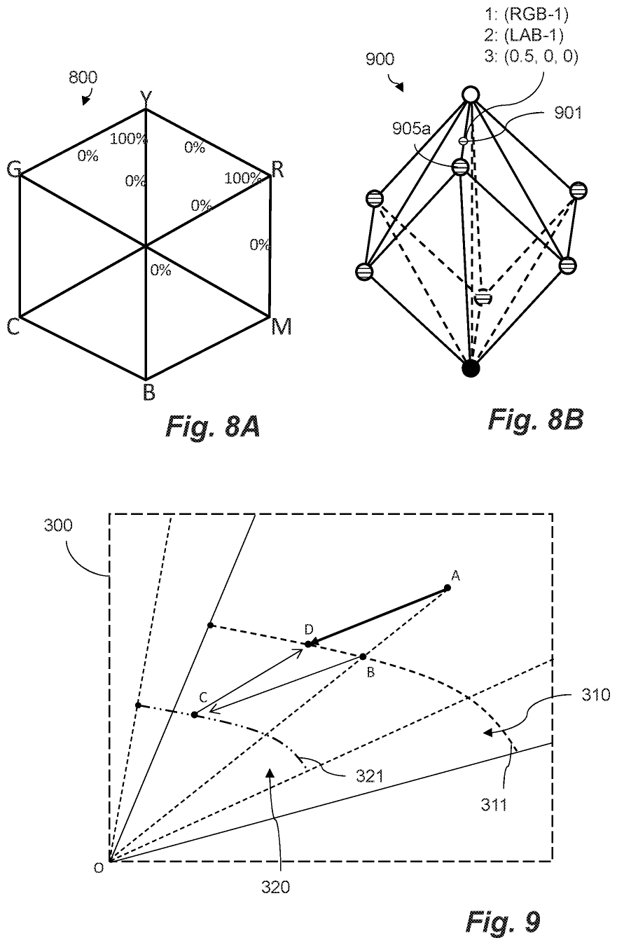

The above-described method may therefore provide for a perceptually uniform mapping between the first gamut 310 and the second gamut 320 which maintains the linearity of the second color space 400 used by the imaging device 260. In certain examples, which will be explained below with reference to FIG. 8, a weighting is applied such that the morphing between the first gamut 310 and the second gamut 320 is done to a different degree.

Referring now to FIGS. 8A and 8B, a weighting map 800 for use in example methods described herein is shown in FIG. 8A. In an example, weighting map 800 is applied in the process of producing a morphed gamut 900 which is produced by morphing the cube 410a to the cube 420a to a degree determined by the weighting map 800. The weighting map 800 comprises a plurality of values denoting a weighting, for example as a percentage value, to be applied when mapping colorimetry, i.e. L*a*b values of one cube 410a to the other cube 420a. The shape of the example weighting map 800 corresponds to the cubes 410a, 420a, although in FIG. 8A the weighting map 800 is viewed along its gray axis. The weighting map 800 is a cube which comprises weighting values for a plurality of points corresponding to points of the cubes 410a and 420a. Six vertices of the weighting map 800 are visible in FIG. 8 corresponding to, in a clockwise manner, yellow (Y), red (R), magenta (M), blue (B), cyan (C), and green (G) respectively. In this example, values are held by the weighting map 800 which correspond with a percentage weighting to be applied when adjusting the colorimetric value held at a given node of the cube 410a to the colorimetric value held at the corresponding node of the cube 420a. In this example, a 100% weighting value held in the weighting map 800 for the given node indicates that in making the adjustment, the L*a*b value at that node of the cube 410a is adjusted completely to equal the L*a*b value held at the corresponding node of the cube 420a. Conversely a 0% value indicates that the L*a*b value at that node of the cube 410a is not to be adjusted and the L*a*b value of the node in the cube 410a is to be used in the morphed gamut.

In this example, a 100% value is held at the red vertex R, indicating that a 100% weighting is applied when adjusting the L*a*b of the red node 415a of the cube 410a to the L*a*b value of the red node 425a of the cube 420a. That is, the colorimetric value of the red primary of the first gamut 310, i.e. the sRGB gamut, is fully adjusted to equal the colorimetric value of the second gamut 320, i.e. the device-dependent gamut. Similarly, a 100% value is held for the yellow vertex. In this example, values of 0% are held for all other positions in the weighting map 800. This indicates that in this example the L*a*b values of the red primary and the yellow primary of the first gamut 310 should be adjusted, and the colorimetry of all other points within the first gamut 310 should be left unchanged. In some examples, the weighting map 800 may comprise weighting values corresponding to each of the nodes of the cubes 410a and 420a. In other examples, the weighting map 800 may comprise weighting values for some but not all of the nodes of the cubes 410a, 420a. In such examples, during the mapping operation of the cube 410a to the cube 420a, an interpolation operation may be performed to provide weighting values corresponding to the nodes for which a weighting value is not provided for by weighting map 800.

In the example of FIGS. 8A and 8B, the weighting map 800 is shown to have a value of 0% corresponding to the nodes representing the mid-point of the white to red ramp, i.e. corresponding to the nodes 551 and 501 of the cubes 410a and 420a respectively. Therefore, in the morphed gamut 900, produced by applying the weighting map 800 and morphing the cube 410a to the cube 420a, the node 901 of the morphed gamut 900 which corresponds to the nodes 551 and 501, has an L*a*b value of LAB-1. That is, the L*a*b value of the node 501 is unchanged from the L*a*b value of the node in the aligned first gamut 310a.

In another example, a weighting value stored for a point in the weighting map, for example the green point, may be 20%. In such an example, the colorimetric value of the green point in the cube 410a is adjusted determined as follows. Where the colorimetric L*a*b value at the green point of the cube 410a is LAB-1 and the colorimetric L*a*b value at the green point of the cube 420a is LAB-2, the L*a*b value for the green point is adjusted to equal: 0.8*LAB-1+0.2*LAB-2.

In some examples, color data is mapped from the second gamut 320 to the first gamut 310 rather than from the first gamut 310 to the second gamut 320 as described in the example above. The same advantages provided for in the above example may also apply in this mapping in the reverse direction. That is, the linearity of the first gamut 310 is respected when mapping colors of the second gamut 320 to the first gamut 310.

In methods described herein, colorimetric values may be adjusted for particular points which are within both the first gamut 310 and the second gamut 320, for example as described above. The methods may be contrasted with a method in which points having colorimetric values in both gamuts are preserved and points outside one gamut but inside of the other are mapped to a point in the gamut which they lie outside, which may be referred to a relative colorimetric mapping. Certain examples described herein may therefore provide color mapping which makes fuller use of available colorants, e,g, native inks, when using an imaging device 260 with a particular output gamut. Example methods may result in a departure to some extent from the original color content but this in turn may result in more vividness of colors through utilizing the native primaries of the imaging device 260 to a fuller extent. That is, while in some examples the colorimetric value of a particular color in the first gamut 310, e.g. the sRGB reference gamut, is preserved when converting from the first gamut 310 to the second gamut 320, in other examples the overall color reproduction may involve not preserving the colorimetric value of the particular color from the first gamut 310. Near the boundaries, and provided that the shapes of the first gamut 310 and the second gamut 320 are different, undesired effects may arise with a trivial mapping such as a relative colorimetric mapping: out of the destination gamut colors may be clipped and so smooth transitions in the original gamut cannot be encoded properly for the imaging device 260. In this case, examples described herein provide a method of adjusting the colorimetry of an image to produce a particular result.

The type of color mapping e.g. the weighting values used, between the first gamut 310 and the second gamut 320 can depend on the capabilities of the imaging device 260 to represent the colors of the first gamut 310. For example, the second, device, gamut 320 may be smaller, i.e. represent a smaller set of colors, than the first, reference, gamut 310. There may be several possible mappings between a first gamut 310, and a second gamut 320, which may result in different visual effects in an image output by the imaging device 260. A particular mapping may be chosen based on these resulting visual effects based on the circumstances, for example based on the image type, intended use of the image produced or the desired visual effect. For example, a more comprehensive morphing of the first gamut 310 to the second gamut 320 may be chosen for use with graphics which are not photographs, for example computer graphics, where close reproduction of colorimetric values is not a particular concern.

Certain factors may influence the desirability of a particular weighting when mapping between gamuts. For example, the actual mapping used may determined with consideration of content type, for example, how is the output image to be displayed or viewed and/or what is its purpose; is the source/output image high contrast or intended to show detailed color transitions, and/or user preference. The particular weighting values for mapping between points in the first gamut and the second gamut may be determined based on the position of a given point within the gamut. For example, points far from a boundary of the first gamut and the second gamut may have a low percentage weighting value, such that the colorimetric value of a color being converted from one gamut to the other is substantially preserved. In one example, points in the first gamut 310 which are close to skin tones, e.g. for use in reproducing photographs, may have a low weighting value, so as to preserve the colorimetric value of skin tone colors. Points nearer the boundary of either or both of the gamuts, which in examples may be points close to primary colors, may have a higher percentage weighting value. For example, points in the first, reference, gamut 310 close to a primary color may be mapped to a greater extent to the corresponding point in the second gamut 320, which may allow for fuller use of the colors available to the imaging device 260.

FIG. 9 shows a schematic representation of an example method of extending the mapping between the first gamut 310 and the second gamut 320 to colorimetric points in the first color space 300 which are outside of both gamuts. That is, in examples, a point A in first color space 300 which is outside of both the first gamut 310 and the second gamut 320 is mapped to a point in the first gamut 310 and a point C in the second gamut 320. In the example of FIG. 9, a point A is within the first color space 300 but outside of the first gamut 310 and the second gamut 320. In this example, the point A is transposed to a point B on the surface of the first gamut 310, wherein the first gamut 310 in a region of interest is wider than the second gamut 320. The point B in this example is located at the intersection between: a straight line in the first color space 300 between the origin 0 and the point A, and a boundary 311 of the first gamut 310. It is determined from the mapping determined by the above-described method that the point B is mapped to the point C by said mapping. In this example, the point B on the boundary 311 of the first gamut 310 is mapped to the point C on a boundary 321 of the second gamut 320. In the example method, the same mapping operation used to map the point B to the point C is then applied to the point A. This results in the point A being mapped to obtain the point ID within the first gamut 310. The process described with reference to point A may be performed for a plurality of points within the color space 300, for example for all points within color space 300 and outside of both the first gamut 310 and the second gamut 320. This provides for points in the color space 300, in this example the PCS, such as point A, which are outside of both the first gamut 310 and the second gamut 320, to be represented within the morphed gamut. This may, for example, allow for the color at the point A to be represented with the imaging device 260, having the second gamut 320 available to it, despite the point A falling outside of both the first gamut 310 and the second gamut 320.

Examples in the present disclosure can be provided as methods, systems or machine readable instructions. Such machine readable instructions may be included on a computer readable storage medium, such as disc storage, CD-ROM, optical storage, etc., having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus the functional modules or functional units of the apparatus and devices may be implemented by a processor executing machine readable instructions stored in a memory, or a processor operating in accordance with instructions embedded in logic circuitry. The terms processor and processing circuitry may include a CPU, processing unit, ASIC, logic unit, or programmable gate array etc. In examples, the methods and functional modules may all be performed by a single processor or divided amongst several processers.

Above-described examples of the mapping process may be considered to provide a device characterization mapping. That is, a mapping is obtained from the CIELAB values of the reference gamut, such as the sRGB gamut, to the RGB color space of a device being characterized. This may be considered to produce a characterization of the device color behavior which characterizes the device with a behavior which is altered when compared to the normal behavior of the device. For example, the mapping produced by the above-described method could be implemented by a selection of a type of rendering intent using a device ICC profile such as an input ICC profile for a capturing device or an output ICC profile for a reproduction device. In examples, an example method is implemented based on a selection of a rendering intent using such a device ICC profile. For example, an example method could be implemented during an implementation of a perceptual rendering intent, or a saturation rendering intent. It should be noted that, in other examples, the described method may be implemented in what may be referred to as a device mapping characterization. That is, the resulting characterization produced by the method described above may be encoded as a device link ICC profile. Since through the above method, a mapping may be produced which maps from the color values of the source gamut, e.g., the RGB color values of the sRGB gamut or other RGB or CMYK values, to the color space of the device, e.g. the device-dependent RGB color values of the device or the device-dependent CMY/CMYK color values of the device, In yet another example, the method may be used to produce what may be referred to as a color mapping characterization. That is, the resulting characterization produced by the method described above may be encoded as a mapping between CIE LAB values of a first gamut and CIE LAB values of the second gamut. Such a characterization may in examples be encoded in an abstract ICC profile, for converting between CIE LAB values of one gamut to CIE LAB values of another gamut.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples,

What is claimed is:

1. A method comprising:
obtaining, at a processor, a first color gamut represented in a first color space;
obtaining, at the processor, a second color gamut represented in the first color space;
representing the first color gamut as a first object in a second color space, and representing the second color gamut as a second object in the second color space, wherein:
the first object in the second color space comprises a first plurality of nodes and the second object in the second color space comprises a second plurality of nodes;
wherein
for each node of the first plurality of nodes and each node of the second plurality of nodes there is provided an index indicating a position in the first color space to which that node corresponds; and
for each node of the first plurality of nodes and each node of the second plurality of nodes there is provided a further index, wherein, for a node of the first plurality of nodes, the further index is indicative of a position, in the first color space, of the node relative to at least one other node of the first plurality of nodes, and wherein, for a node of the second plurality of nodes, the further index is indicative of a position, in the first color space, of the node relative to at least one other node of the second plurality of nodes;
providing a mapping between the first object and the second object by corresponding each node of the first plurality of nodes with a node of the second plurality of nodes and each node of the second plurality of nodes with a node of the first plurality of nodes by using the further index; and
adjusting the index of at least one of the first plurality of nodes based on the index of the node of the second plurality of nodes to which the node of the first plurality of nodes corresponds, to thereby produce a mapping between the first gamut and the second gamut.

2. The method of claim 1, wherein representing the first color gamut as a first object in the second color space, and representing the second color gamut as a second object in the second color space, comprises:
for each of the first object and second object, representing a black point of the gamut represented by that object with a first node of the object, and representing a white point of the gamut by a second node of the object, wherein the first node and the second node represent opposite vertices of the object, and wherein for each object an axis of the object joining the first node and the second node represents a gray axis of the gamut which that object represents.

3. The method of claim 1, wherein representing the first color gamut as the first object and representing the second color gamut as the second object in the second color space comprises, for each object:
determining, for each edge connecting a first vertex and a second vertex of the object, a point along the edge having a first index which indicates a position in the first color space which is equidistant from the position in the first color space indicated by a first index of the first vertex and a first index of the second vertex; and
defining the point as a node and providing a further index for the node which indicates that the node is equidistant from the position in the first color space indicated by the first index of the first vertex and the first index of the second vertex.

4. The method of claim 3, wherein representing the first color gamut as a first object and representing the second color gamut as a second object in the second color space comprises, for each object:
dividing the object into a plurality of sub-objects having a plurality of vertices; and
determining for each edge connecting a pair of vertices of each sub-object a point which lies on the edge and has a first index which indicates a position in the first color space which is equidistant from the positions in the first color space indicated by the first indices of the pair of vertices; and
defining the point as a node and providing a further index for the node which indicates that the node has a first index which indicates a position in the first color space which is equidistant from the positions in the first color space indicated by the first indices of the pair of vertices.

5. The method of claim 4, comprising further dividing each of the sub-objects once or a plurality of times, wherein for each division the object formed by the division comprises a set of vertices and the method comprises, for the object formed by the division;
determining for each edge connecting a pair of vertices of each object formed by the division a point which lies on the edge and has a first index which indicates a position in the first color space which is equidistant from the positions in the first color space indicated by the first indices of the pair of vertices; and
defining the point as a node and providing a further index for the node which indicates that the node has a first index which indicates a position in the first color space which is equidistant from the positions in the first color space indicated by the first indices of the pair of vertices.

6. The method of claim 1 wherein providing a mapping between the first object and the second object by corresponding each node of the first cube with each node of the second cube using the further index comprises corresponding each node of the first cube with the node of the second cube having the same value of the further index as the node of the first cube.

7. The method of claim 1, wherein the first color space has a gray axis and the method comprises aligning the first color gamut and the second color gamut about the gray axis of the first color space.

8. The method of claim 1, wherein the first color space is a substantially perceptually uniform color space, and the second color space is a device dependent color space.

9. The method of claim 1, wherein the first gamut is a reference gamut and the second gamut is a device gamut, or wherein the first gamut is a device gamut and the second gamut is a reference gamut.

10. The method of claim 1, comprising applying a weighting map which for each of the nodes of the first object denotes a degree to which the index of that node is adjusted to the index of the corresponding node of the second object.

11. The method of claim 1, comprising mapping a point in the color space which is outside of both the first gamut and the second gamut to a point in the first gamut or the second gamut.

12. A method comprising using a mapping between a first gamut and a second gamut produced according to claim 1 to produce a conversion profile between the first gamut and the second gamut.

13. A method comprising:
obtaining a first gamut and a second gamut, each gamut comprising a set of points in a first color space;
representing the first gamut as a first object in a second color space and the second gamut as a second object in the second color space, wherein each object comprises a plurality of vertices and a plurality of edges, and wherein each point in the first object corresponds to a point of the first gamut in the first color space and each point of the second object corresponds to a point of the first gamut in the first color space;
providing a first plurality of nodes for the first object and a second plurality of nodes for the second object wherein each node is located on one of the edges; and
indexing each node based on a distance in the first color space between the point to which the node corresponds and a point to which one of the plurality of vertices corresponds;
providing a mapping between the first plurality of nodes and the second plurality of nodes to allow mapping between values in the first gamut and the second gamut; and
adjusting a point in the first color space to which at least one node of the first plurality of nodes corresponds based on a point in the first color space to which the corresponding node of second plurality of nodes correspond to thereby produce a mapping between the first gamut and the second gamut.

14. A computer readable medium comprising a set of computer readable instructions which when executed by a processor cause the method of claim 1.

15. A computer readable medium comprising a conversion profile which is producible by the method of claim 12.
